(19) United States
(12) Patent Application Publication
(10) Pub. No.: US 2017/0073615 A1
(43) Pub. Date: Mar. 16, 2017

(54) COMPOSITION FOR CLEANING OF HARD SURFACES

(71) Applicant: Akzo Nobel Chemicals International B.V., Arnhem (NL)

(72) Inventors: Mahnaz COMPANY, Hisings Backa (SE); Anette THYBERG, Stenungsund (SE)

(21) Appl. No.: 15/358,454

(22) Filed: Nov. 22, 2016

Related U.S. Application Data
(63) Continuation of application No. 13/991,769, filed on Jun. 5, 2013, now abandoned.
(60) Provisional application No. 61/420,400, filed on Dec. 7, 2010.

(30) Foreign Application Priority Data
Dec. 7, 2010 (EP) 10193983.3

(51) Int. Cl. C11D 1/75; B08B 3/08; B08B 3/02; C11D 11/00; C11D 1/72; C11D 1/835; C11D 3/04; B60S 1/00; C11D 1/62

(52) U.S. Cl. CPC C11D 1/75; B60S 1/00; B08B 3/08; B08B 3/02; C11D 1/62; C11D 1/72; C11D 1/835; C11D 3/044; C11D 11/0023

(57) ABSTRACT

The invention relates to the use of an alkaline aqueous composition comprising

a) an amine oxide
b) a nonionic surfactant, not being an amine oxide, and
c) a cationic hydrotrope having the formula (I)

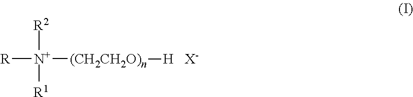

where R=C₆-C₂₂ hydrocarbyl, R¹ and R² are independently C₁-C₄ alkyl, n is at least 12, and at most 25, and X⁻ is an anion, e.g. halide or methylsulphate;
for removal of dirt from hard surfaces. In particular the composition significantly reduces the amount of traffic film remaining on the surface after brushless vehicle cleaning as compared to presently applied formulation concepts. Further, the invention relates to certain such compositions and intermediates to make these.

### CROSS-REFERENCE TO RELATED APPLICATIONS

This application is a continuation of U.S. patent application Ser. No. 13/991,769, filed Jun. 5, 2013, which is a national stage filing under 35 U.S.C. §371 of PCT/EP2011/071687, filed Dec. 5, 2011, which claims priority to U.S. Provisional Patent Application No. 61/420,400 filed Dec. 7, 2010, and European Patent Application No. 10193983.3, filed Dec. 7, 2010, the contents of which are incorporated herein by reference in their entireties.

### TECHNICAL FIELD OF INVENTION

The present invention relates to certain compositions and the use of said compositions for removal of dirt from hard surfaces, especially for brushless cleaning of vehicles, such as e.g. cars and buses.

### TECHNICAL BACKGROUND OF THE INVENTION

Automatic vehicle cleaning methods have been used for many years and there have been many activities in the area of developing new machines, brushes, and chemicals. However, brushless vehicle cleaning is the preferred cleaning method by many customers who want to protect the coating on the surfaces.

It is well known that brushless vehicle cleaning will result in less damage on surfaces. The disadvantage of brushless vehicle cleaning is the grey thin traffic film remaining on the surface after cleaning. This thin film can easily be removed by touching the surface.

In brushless vehicle cleaning the chemicals used and the specific formulation applied play a very important role in reducing the amount of this traffic film that is left on the surface after cleaning. Further, the chemicals should be very effective at low concentration and have minimal environmental impact.

After many years of development in the areas of both equipment and formulations the traffic film still remains a problem.

WO 2005/113735 generally discloses an aqueous cleaning composition for hard surfaces having a pH of less than 7.0 which comprises a) a non-ionic surfactant, more specifically selected from a group consisting of alkoxylated branched or linear alcohols, amine oxides, polyhydritic alcohols, betaines, and mixtures thereof, b) an alkoxylated cationic surfactant, c) a hydroxyl-functional organic solvent, and d) a water soluble organic acid.

WO 03/087280 generally discloses vehicle drying and polishing compositions including a) an alkyl ether amine, b) an alkyl diamine, c) a propoxylated or mixed alkoxylated quaternary ammonium compound exemplified by a compound having two ethyl groups, one methyl group, and one polyoxypropylene group, and d) a stabilizer including neutralising acid and/or a non-ionic surfactant, which may be e.g. an amine oxide, an alkoxylated alcohol that may be end-capped or an alkyl glycoside, or mixtures thereof. The composition may further include an ethoxylated quaternary ammonium compound such as PEG 15 cocomonium chloride.

U.S. Pat. No. 5,929,024 discloses a hard surface cleaning composition comprising at least one surfactant selected from the group comprising e.g. a) an ethoxylated non-ionic, b) an alkyl polyglucoside having a C8-C20 alkyl group, c) an amine oxide, and mixtures thereof, and further comprising e.g. d) an ethoxylated trialkyl ammonium salt which has maximally 5 EO units.

EP 1 074 606 discloses a liquid detergent formulation for use as a hard surface cleaner, comprising alkyl sulphates, alkyl ether sulphates, a betaine surfactant, an ethoxylated alcohol, and a C₈₋₂₂ alkyl polyglycoside, which formulation may also comprise an amine oxide.

U.S. Pat. No. 6,015,780 generally discloses a surfactant composition containing a) a C₁₂ betaine, b) a C₄-C₂₂ alkyl and/or alkenyl oligoglycoside, preferably an oligoglucoside, and c) a fatty alcohol (ether) sulphate, and optionally d) a fatty alcohol ethoxylate and/or e) an amine oxide.

US 2006/0009369 generally discloses a cleaning composition for hard surfaces that may comprise e.g. an ethoxylated alcohol, an amine oxide and/or an alkyl polyglycoside, where C₉C₁₁ alkyl polyglucoside is used as a specific example.

US 2009/0188533 is specifically directed towards formulations for removal of different types of traffic films. The formulations disclosed comprise a) at least one anionic surfactant, b) at least one polyoxyalkylene ammonium cationic surfactant having three C₁-C₄ alkyl groups and one polyoxyalkylene chain, and c) an alkaline agent. Optional additional ingredients may comprise at least one polycarboxylic acid chelating agent, at least one non-ionic or amphoteric surfactant, at least one hydrotrope, inorganic and/or organic acids, and at least one silicate.

So far it appears that the use of certain cationic co-surfactants in combination with non-ionic surfactants has proved to be the best way of reducing the traffic film remaining on the surface when a brushless cleaning method is applied, but still there is room for improvement to minimize this problem, since consumers are asking for better cleaning.

### SUMMARY OF THE INVENTION

It is an object of the present invention to at least partially meet the above-mentioned need in the art and to provide a formulation that exhibits high efficacy in removing dirt from hard surfaces, in particular for brushless cleaning of vehicles.

It is another object of the present invention to provide a formulation comprising compounds that have advantageous environmental properties.

Now it has been found that an alkaline aqueous composition comprising

a) an amine oxide,
b) a nonionic surfactant, not being an amine oxide, and
c) a cationic hydrotrope having the formula (I)

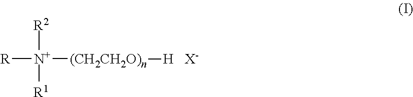

where R=C₆-C₂₂ hydrocarbyl, R¹ and R² are independently C₁-C₄ alkyl, n is at least 12, and at most 25, and X⁻ is an anion, e.g. halide or methylsulphate;
is very efficient for removal of dirt from hard surfaces and in particular significantly reduces the amount of traffic film remaining on the surface after brushless vehicle cleaning as compared to presently applied formulation concepts.

Thus, in a first aspect, the present invention relates to the use of the aforementioned formulation for the cleaning of hard surfaces, especially for brushless vehicle cleaning

In a second aspect, the present invention relates to the aforementioned formulation, as such wherein the weight ratio of the sum of amine oxide and nonionic surfactant to hydrotrope is between 1:3 and 5:3 and with the proviso that if any anionic and/or amphoteric surfactant is present in the composition, then the molar amount of cationic hydrotrope of formula (I) is greater than the molar amount of any anionic groups that are part of an anionic and/or amphoteric surfactant.

The fact that the composition works very well for brushless cleaning should not be interpreted in such a way that it would be limited to such use, since it is very efficient for all kinds of hard surface cleaning.

These and other aspects of the present invention will be apparent from the following detailed description of the invention.

### DETAILED DESCRIPTION OF THE INVENTION

The present invention relates to the use of an alkaline aqueous composition comprising

a) an amine oxide,
b) a nonionic surfactant, not being an amine oxide,
c) a cationic hydrotrope having the formula (I)

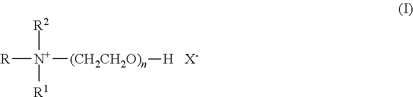

where R=C₆-C₂₂ hydrocarbyl, preferably C₆-C₂₂ alkyl or alkenyl, more preferably C₈-C₂₀ alkyl or alkenyl, and most preferably C₁₀-C₁₈ alkyl or alkenyl; R¹ and R² are independently C₁-C₄ alkyl, preferably methyl or ethyl, and most preferably both R¹ and R² are methyl; n is at least 12, and at most 25, preferably at most 20 and most preferably at most 17; and X⁻ is an anion, e.g. halide or methylsulphate,
d) optionally other conventional additives, and
e) balance water;
for the cleaning of hard surfaces, especially for reducing the amount of traffic film left on the surface after brushless vehicle cleaning.

It is noted that optional additives d) can comprise further surfactants. If any anionic and/or amphoteric surfactant is present in the composition, then the molar amount of cationic hydrotrope of formula (I) is greater than the molar amount of any anionic groups that are part of an anionic and/or amphoteric surfactant. However, preferably no anionic surfactant is present in the composition. In another embodiment no anionic or amphoteric surfactant is present.

Another aspect of the present invention is the alkaline aqueous composition described above per se, wherein the weight ratio of the sum of amine oxide and nonionic surfactant to hydrotrope is between 1:3 and 5:3.

The term “anionic groups” means anionic groups that are covalently bound within the anionic or the amphoteric surfactant. For example, a sulphate group of an alkyl sulphate having the formula R—OSO₃⁻A⁺, where R is an hydrocarbyl group with at least 6 carbon atoms, is covalently bound to the hydrocarbyl group R, and these groups together constitute the anionic surfactant. Counterions, such as X⁻ in formula I, e.g. CH₃OSO₃⁻, are not to be taken into account in this context. Further, amine oxides are not to be considered as amphoteric surfactants in this context. If any anionic and/or amphoteric surfactant is present in the composition, the molar ratio of anionic groups of the surfactant to cationic surfactant of formula (I) is less than 1:1, preferably less than 1:2, and more preferably less than 1:3. Most preferably, the aqueous composition is free of anionic and amphoteric surfactants. The reason for this is to avoid complexation between the cationic hydrotrope having formula (I) and anionic surfactants, which complexation is not desirable since it would interfere with the solubilisation of the nonionic surfactant by the cationic hydrotrope.

Nonionic surfactants are known to be good wetting agents, and are often present in compositions for the cleaning of hard surfaces. Most often hard surface cleaning compositions contain alkaline components. Many nonionic surfactants are not soluble enough in aqueous solutions, especially those with a high amount of electrolytes present, such as alkali hydroxides, alkaline builders and/or complexing agents, and therefore need the presence of a hydrotrope to improve their solubility. A good hydrotrope is not necessarily a good wetting agent. Its main task is to enhance the solubility of the nonionic surfactant and so increase the wetting ability of the composition, because the otherwise insoluble nonionic surfactant now is dissolved and can exert its wetting ability. A number of hydrotropes for nonionic surfactants have been described in various publications.

Examples of such hydrotropes are ethanol, sodium xylene sulphonate, sodium cumene sulphonate, alkyl glycosides, and alkoxylated quaternary ammonium compounds.

An alkaline composition is herein defined as a composition having a pH>7, which pH is obtained by the addition of an alkaline agent, such as alkali hydroxides, alkaline builders and/or alkaline complexing agents. In one embodiment the pH is above 7.1 and in another embodiment it is above 7.5. In the context of the present invention pH is given as the value obtained when measured for the composition at 25° C. The alkali hydroxides are preferably sodium or potassium hydroxide. The alkaline builders could be an alkali carbonate or an alkali hydrogen carbonate, such as sodium carbonate, potassium carbonate, sodium hydrogen carbonate or potassium hydrogen carbonate, an alkali salt of a silicate, such as sodium silicate or sodium metasilicate, or alkali salts of phosphates, such as sodium orthophosphate. Alkaline builders which act through complexation are e.g. sodium pyrophosphate and sodium tripolyphosphate and the corresponding potassium salts. Examples of organic builders/complexing agents are aminocarboxylates, such as sodium nitrilotriacetate (Na₃NTA), sodium ethylenediaminetetraacetate (EDTA), sodium diethylenetriaminepentaacetate, sodium 1,3-propylenediaminetetraacetate, and sodium hydroxyethylethylenediaminetriacetate; aminopolyphosphonates, such as nitrilotrimethylenephosphonate; organic phosphates; polycarboxylates, such as citrates; polymeric carboxylates, and alkali salts of gluconic acid, such as sodium or potassium gluconates.

The amine oxide component preferably has the formula

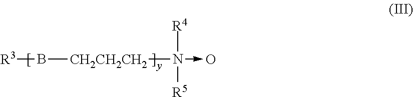

where R³ is a hydrocarbyl or acyl group containing 8-22 carbon atoms, B is O or NH and y is 0 or 1, provided that when R³ is an acyl group, y must be 1; R⁴ and R⁵ are independently a C₁-C₄ alkyl group or the group (AO)_{z}H, where AO is an alkyleneoxy group having 2-4 carbon atoms and z is a number from 1 to 5.

It is noted that amine oxides are sometimes classified as nonionic surfactants, sometimes as amphoteric surfactants, sometimes as zwitterionic surfactants, sometimes as cationic surfactants, and sometimes mentioned as a specific group of surfactants. To avoid confusion, amine oxides are herein treated as a specific group of surfactants and not considered to generally belong to the group of nonionic surfactants, amphoteric surfactants, cationic surfactants or any other general group of surfactants.

The nonionic surfactant component is preferably an alkylene oxide adduct, suitably an alcohol alkylene oxide adduct, that preferably has the formula

R⁶O—(PO)ₐ(EO)_{b}(PO)_{c}H (IV)

where R⁶ is a C₈ to C₁₈ alkyl group, preferably C₈ to C₁₂, PO is a propyleneoxy unit, EO is an ethyleneoxy unit, a=0-5, preferably 0-4, and most preferably 0-2; b=1-20, preferably 1-12, more preferably 2-8 and most preferably 2-5; and c=0-5, preferably 0-4, more preferably 0-2, and most preferably 0. Thus, the C₈-C₁₈-alcohol alkoxylates may, in addition to the 1-20 ethyleneoxy units, also contain up to 5 propyleneoxy units. The number of propyleneoxy units, when present, may be as small as 0.1 mole PO per mole alcohol. The ethyleneoxy units and the propyleneoxy units may be added randomly or in blocks. The blocks may be added to the alcohol in any order. The alkoxylates may also contain an alkyl group with 1-4 carbon atoms in the end position. Preferably, the alkoxylates contains 2-8 ethyleneoxy units and 0-2 propyleneoxy units. The alkyl group of the nonionic surfactants may be linear or branched, saturated or unsaturated. Suitable linear nonionic surfactants are C₉-C₁₁ alcohol+4, 5 or 6 moles of EO, C₁₁ alcohol+3, 4, 5, 6, 7 or 8 moles of EO, tridecyl alcohol+4, 5, 6, 7 or 8 moles of EO, and C₁₀-C₁₄ alcohol+8 moles of EO=2 moles of PO. Suitable branched nonionic surfactants are 2-ethylhexanol+3, 4 or 5 moles of EO, 2-ethylhexanol+2 moles of PO+4, 5 or 6 moles of EO, 2-propylheptanol+3, 4, 5 or 6 moles of EO, and 2-propylheptanol+1 mole of PO+4 moles of EO. Another example is 2-butyloctanol+5, 6 or 7 moles of EO. Wherever the degree of alkoxylation is discussed, the numbers referred to are molar average numbers.

The composition to be used in the present invention may be a concentrate or a ready-to-use solution and preferably comprises

i) 0.03-20% by weight of the amine oxide,
ii) 0.03-20% by weight of the nonionic surfactant,
iii) 0.015-20% by weight of the hydrotrope,
iv) 0.03-40% by weight of alkali hydroxides, alkaline builders and/or alkaline complexing agents,
v) optionally other conventional additives, and
vi) balance water.

The lower part of the range pertains to diluted ready-to-use solutions and the higher part to concentrated solutions. The concentrated solutions offer the advantage of reduced transportation costs and ease of dilution and handling. A typical concentrate can be diluted 80 to 200 times to form the ready-to-use solutions. It is noted that such dilution can be performed in one or more steps, for example a concentrate can be diluted 50 times, then provided to the end user, and further diluted 4 times to get a ready-to-use solution. In a supply chain this can be the most effective way of getting an accurate degree of dilution, while minimizing transport costs.

The weight ratio of amine oxide to nonionic surfactant is normally between 1:2 and 8:3, and the weight ratio of the sum of amine oxide and nonionic surfactant to hydrotrope is normally between 1:3 and 5:3.

The concentrated compositions of the present invention are clear, or slightly hazy, and stable. The clarity interval is suitably between 0-30° C., preferably between 0-40° C., more preferably between 0-50° C., and most preferably between 0-60° C. or higher. This could be adapted by changing the relative amounts of hydrotrope, amine oxide and nonionic surfactant. The concentrate normally contains at least 50% by weight of water, suitably at least 70% by weight, and normally at most 95% by weight of water, suitably at most 90% by weight.

Another embodiment of the invention relates to intermediates that are useful for making the formulations of the invention. More specifically, due to transportation requirements a concentrate may be made without the alkaline components, and such concentrates may be free of water, or contain less than 50% water. Accordingly the invention also relates to intermediates comprising

0.5-50% w/w of one or more amine oxides,
0.5-50% w/w of one or more nonionic surfactants,
0.5-50% w/w of one or more cationic hydrotropes having the formula (I)

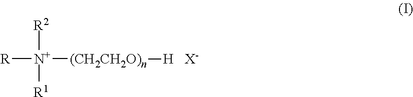

where R=C₆-C₂₂ hydrocarbyl, R¹ and R² are independently C₁-C₄ alkyl, n is at least 12, and at most 25; and X⁻ is an anion,
optionally other conventional additives, and
0.0-50% w/w of water,
up to a total of 100% by weight, whereby the pH of the intermediate is below 8. In one embodiment the pH of the intermediate is below 7.5. In another embodiment the pH is above 7.0, preferably above 7.1. Such intermediates can be diluted with water and, if needed, combined with an alkaline agent as described above, to form a formulation of the present invention.

All embodiments of the invention may further contain other hydrotropes and surfactants, and conventional additives, such as thickening agents, solvents, colourants, soil antiredeposition agents, preservatives, corrosion inhibitors, and foam regulators.

### GENERAL EXPERIMENTAL

To evaluate the cleaning efficiency of different formulations at different dilutions, the following procedure was used:

### High Pressure Cleaning Test

Whiteboard 5.5×9 cm plates are treated with Turtle wax® wax Extra with PTFE (polytetrafluoroethylene), polished with a soft cloth, and then an oil-soot mixture obtained from train diesel engines is applied on the plates. This is a very tough type of soil to remove, and it is used to simulate a worst case of traffic film. The reflectance of each plate is measured with a Minolta Chroma Meter CR-200 reflectometer first after waxing and then after soiling. The plates are then magnetically fixed to a larger board. A container filled with the cleaning liquid is connected through a tube to a pump that is further connected by a tube to a flat-fan spray nozzle mounted on a stand that is moveable both vertically and horizontally, manoeuvred by a cable and an electric motor and by application of compressed air. The cleaning liquid is applied on the plates by pumping it through the flat-fan spray nozzle at a pressure of 4 bar with a liquid flow rate of about 2 l/min, min, while the nozzle is moved horizontally in front of the plates. For the rinsing step a set of three cone jet nozzles connected to a tap water pipe via a high pressure pump is used. These nozzles are also mounted on the above-mentioned stand. One minute after the application of the cleaning liquid the plates are rinsed by pumping tap water through the set of nozzles at a pressure of 80 bar with a liquid flow of about 4.5 l/min, using a plunger pump of Type P21/23-130 from Speck-Kolbenpumpenfabrik in Austria, while the nozzles are moved horizontally in front of the plates while at the same time swinging up and down. Between the cleaning tests the tube is carefully flushed by pumping tap water through it to remove any remaining cleaning liquid from the previous test. After the rinse the reflectance of each plate is once again measured with the reflectometer. The cleaning ability is presented either as the % soil removal (comparison between the cleaned plates and the soiled plates) or as the loss of lightness (comparison between the cleaned plates and the waxed, unsoiled plates). For a good cleaning composition the loss of lightness values obtained should thus be as low as possible.

Note that the values given are to be used only as relative, not absolute values.

The values to be compared should be obtained with the same batch of oil-soot mixture being used. For each test run with a specific composition 3 plates are used, and the test is performed at least twice. Where nothing else is stated, the values are thus the average results of tests performed on at least six plates. The range wherein the results were found is given for each test.

All solutions and the water were kept at a temperature of 15-20° C. In all following examples all percentages are by weight, unless otherwise specified.

### Example 1

Compositions with the reagents specified in Table 1 were made. The hydrotrope was added in such an amount that the solution exhibited the clarity interval stated. The test solutions were diluted to 1:40 and 1:80. The cleaning ability of the diluted test solutions was evaluated by the high pressure cleaning test described above, and the results are collected in Table 2.

TABLE 1

| | Composition | Composition | Composition |
|---|---|---|---|
| Ingredient | 1¹ | A¹ | B¹ |
| C₉-C₁₁-alcohol + 4EO² | 3 | 3 | 3 |
| (C12-C14 alkyl)methyl- | 1.5 | | |
| amine + 15EO, methyl | | | |
| chloride quaternised³ | | | |
| n-hexyl polyglucoside⁴ | | 1.88 | |
| SCS (sodium cumene | | | 1.8 |
| sulphonate)⁵ | | | |
| Tetradecyldimethyl- | 2.5 | 2.5 | 2.5 |
| amine oxide⁷ | | | |
| IDS⁸ | 4.08 | 4.08 | 4.08 |
| NaOH⁹ | 1 | 1 | 1 |
| Water | balance | balance | balance |
| Clarity interval (° C.) | 0-55 | 0-34 | 0-44 |

¹All amounts are given as % by weight, and refer to the active amount of the respective component in the composition.
²Berol ® OX-91-4;
³Berol ® R648;
⁴AG 6206;
⁵ex Stephan;
⁷Aromox ® 14D-W970;
⁸iminodisuccinate ex Bayer;
⁹ex Merck

TABLE 2

| | Removed soil (%) at | Removed soil (%) at |
|---|---|---|
| Composition | dilution 1:40 | dilution 1:80 |
| 1 | 90 ± 5 | 53 ± 11 |
| A (Comparison) | 88 ± 7 | 10 ± 3 |
| B (Comparison) | 83 ± 7 | 8 ± 2 |

### Examples 2-3

Compositions with the reagents specified in Table 3 were made. The hydrotrope was added in such an amount that the solution exhibited the clarity interval stated. The test solutions were diluted to 1:20 with water. The cleaning ability of the diluted test solutions was evaluated by the cleaning test described below, and the results are collected in Table 4.

### Cleaning Test:

White-painted plates were smeared with an oil-soot mixture obtained from train diesel engines. 25 ml of the test solutions, in this case formulations 2, C, and 3 in Table 3 diluted to 1:20, were poured onto the top of the oil-smeared plates and left there for one minute. The plates were then rinsed with a rich flow of water. All solutions and the water were kept at a temperature of about 15-20° C. All test solutions were placed on the same plate, and the result is presented as a ranking of the compounds, where 1 is judged by ocular inspection as the best result. The results are collected in Table 4.

TABLE 3

| | Composition | Composition | Composition |
|---|---|---|---|
| Ingredient | 2 | C | 3 |
| C₉-C₁₁-alcohol + 6EO | 3 | 3 | 3 |
| (C12-C14 alkyl)methyl- | 1.2 | 1.2 | 1.2 |
| amine + 15EO, methyl | | | |
| chloride quaternized | | | |
| Tetradecyldimethyl- | 1.25 | — | 2.5 |
| amine oxide | | | |
| IDS | 4.08 | 4.08 | 4.08 |
| NaOH | 1 | 1 | 1 |
| Water | balance | balance | balance |
| Clarity interval (° C.) | 0->60 | 0->60 | 0->60 |

TABLE 4

| Composition | Ranking order |
|---|---|
| 2 | 2 |
| C (Comparison) | 3 |
| 3 | 1 |

The comparative composition without amine oxide has the lowest ranking.

### Example 4

In this example a less soluble non-ionic surfactant was used than in Examples 2-3. Compositions with the reagents specified in Table 5 were made. The hydrotrope was added in such an amount that the solution exhibited the clarity interval stated. The test solutions were diluted to 1:20. The cleaning ability of the diluted test solutions was evaluated by the high pressure cleaning test as described under General Experimental. The loss of lightness values obtained from the high pressure cleaning test are displayed in Table 6.

TABLE 5

| | Composition | Composition |
|---|---|---|
| Ingredient | 4 | D |
| C₉-C₁₁-alcohol + 4EO | 3 | 3 |
| (C12-C14 alkyl)methyl- | 1.2 | 1.2 |
| amine + 15EO, methyl | | |
| chloride quaternized | | |
| Tetradecyldimethyl- | 2.5 | — |
| amine oxide | | |
| IDS | 4.08 | 4.08 |
| NaOH | 1 | 1 |
| Water | balance | balance |
| Clarity interval (° C.) | 0-42 | Hazy at RT |

TABLE 6

| | High pressure cleaning test |
|---|---|
| Composition | (Loss of lightness values) |
| 4 | 0.2 ± 0.2 |
| D (Comparison) | 0.6 ± 0.2 |

It is clearly shown that the addition of an amine oxide to a cleaning composition results in a composition having a better cleaning performance (lower loss of lightness). Further, the composition with the amine oxide added has a broader clarity interval.

### Example 5

In this example the effect of the removal of the nonionic surfactant or the nonionic surfactant+hydrotrope from the composition is demonstrated. Compositions with the reagents specified in Table 7 were made. The total active content of surfactants in each formulation is 6.7% (w/w). Composition 5 is according to the invention, in composition E the nonionic surfactant is lacking, and in composition F both the nonionic surfactant and the hydrotrope are lacking.

The test solutions were diluted to 1:60. The cleaning ability of the diluted test solutions was evaluated by the high pressure cleaning test as described under General Experimental. The % removed soil values obtained from the high pressure cleaning test are displayed in Table 8.

TABLE 7

| | | Composition | Composition |
|---|---|---|---|
| | Composition | E | F |
| Ingredient | 5 | (Comparison) | (Comparison) |
| C₉-C₁₁-alcohol + 4EO | 3 | — | — |
| (C12-C14 alkyl)methyl- | 1.2 | 1.2 | — |
| amine + 15EO, methyl | | | |
| chloride quaternized | | | |
| Tetradecyldimethyl- | 2.5 | 5.5 | 6.7 |
| amine oxide | | | |
| IDS | 4.08 | 4.08 | 4.08 |
| NaOH | 1 | 1 | 1 |
| Water | balance | balance | balance |

TABLE 8

| | Removed soil (%) at |
|---|---|
| Composition | dilution 1:60 |
| 5 | 61 |
| E (Comparison) | 44 |
| F (Comparison) | 31 |

From the examples above it is thus clear that the components a), b), and c) in the composition of the invention all make a positive contribution to the good cleaning effect, and also that the effect is synergistic, since it is not possible to compensate by adding more of one component if another one is absent from the composition.

1. A method for cleaning vehicle surfaces, the method comprises contacting the vehicle surfaces with an alkaline aqueous composition comprising
a) 0.03-20% by weight of an amine oxide,
b) 0.03-20% by weight of a nonionic surfactant, not being an amine oxide,
c) 0.015-20% by weight of a cationic hydrotrope having the formula (I) 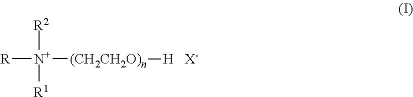
where R=C₆-C₂₂ hydrocarbyl, R¹ and R² are independently C₁-C₄ alkyl, n is at least 12, and at most 25; and X⁻ is an anion and further wherein the weight ratio of the sum of amine oxide and nonionic surfactant to hydrotrope is between 1:3 and 5:3,
d) 0.03-40% by weight of alkali hydroxides, alkali builders and/or alkaline complexing agents;
e) optionally other conventional additives selected from the group consisting of hydrotropes, surfactants, thickening agents, solvents, colorants, soil antiredeposition agents, preservatives, corrosion inhibitors and foam regulators, and
f) balance water;
with the proviso that if any anionic and/or amphoteric surfactant is present in the composition, then the molar amount of cationic hydrotrope of formula (I) is greater than the molar amount of any anionic groups that are part of an anionic and/or amphoteric surfactant.

2. The method of claim 1 where the composition comprises an anionic and/or an amphoteric surfactant, wherein the molar ratio of anionic groups in the anionic and/or the amphoteric surfactant to cationic hydrotrope is less than 1:3.

3. The method of claim 1 where the composition is free of anionic and amphoteric surfactants.

4. The method of claim 1 where the composition comprises alkali hydroxides, alkaline builders and/or alkaline complexing agents.

5. The method of claim 1 where the amine oxide has the formula 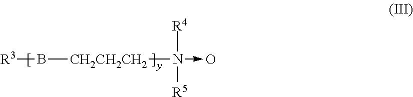
where R³ is a hydrocarbyl or acyl group containing 8-22 carbon atoms, B is O or NH and y is 0 or 1, provided that when R³ is an acyl group, y must be 1; R⁴ and R⁵ are, independently, a C₁-C₄ alkyl group or the group (AO)_{z}H, where AO is an alkyleneoxy group having 2-4 carbon atoms and z is a number from 1 to 5.

6. The method of claim 1 where the nonionic surfactant has the formula
R⁶O—(PO)ₐ(EO)_{b}(PO)_{c}H (IV)
where R⁶ is a C₈ to C₁₈ hydrocarbyl group, PO is a propyleneoxy unit, EO is an ethyleneoxy unit, a=0-5, b=1-20, and c=0-5.

7. The method of claim 1 where the weight ratio of amine oxide to nonionic surfactant is between 1:2 and 8:3.

8. The method of claim 1 for brushless vehicle cleaning, optionally with a water jet spray apparatus.

9. The method of claim 1 further comprising the step of rinsing the said surfaces by using a water jet spray apparatus.

10. A method for cleaning vehicle surfaces, the method comprises contacting the vehicle surfaces with an alkaline aqueous composition comprising
a) 0.015-20% by weight of a cationic hydrotrope having the formula (I) 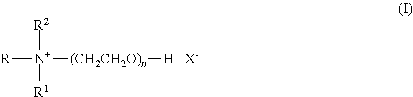
where R=C₆-C₂₂ hydrocarbyl, R¹ and R² are independently C₁-C₄ alkyl, n is at least 12, and at most 25; and X⁻ is an anion and further wherein the weight ratio of the sum of amine oxide and nonionic surfactant to hydrotrope is between 1:3 and 5:3,
b) 0.03-20% by weight of a nonionic surfactant, not being an amine oxide having the formula (II)
R⁶O—(PO)ₐ(EO)_{b}(PO)_{c}H (II)
where R⁶ is a C₈ to C₁₈ hydrocarbyl group, PO is a propyleneoxy unit, EO is an ethyleneoxy unit, a=0-5, b=1-20, and c=0-5,
c) 0.03-20% by weight of an amine oxide having the formula (III) 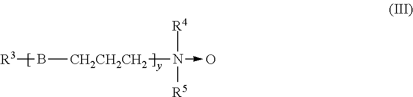
where R³ is a hydrocarbyl or acyl group containing 8-22 carbon atoms, B is O or NH and y is 0 or 1, provided that when R³ is an acyl group, y must be 1; R⁴ and R⁵ are, independently, a C₁-C₄ alkyl group or the group (AO)_{z}H, where AO is an alkyleneoxy group having 2-4 carbon atoms and z is a number from 1 to 5
d) 0.03-40% by weight of alkali hydroxides, alkali builders and/or alkaline complexing agents;
e) optionally other conventional additives selected from the group consisting of hydrotropes, surfactants, thickening agents, solvents, colorants, soil antiredeposition agents, preservatives, corrosion inhibitors and foam regulators, and
f) balance water;
with the proviso that if any anionic and/or amphoteric surfactant is present in the composition, then the molar amount of cationic hydrotrope of formula (I) is greater than the molar amount of any anionic groups that are part of an anionic and/or amphoteric surfactant.

11. An alkaline aqueous composition comprising
a) 0.03-20% by weight of an amine oxide,
b) 0.03-20% by weight of a nonionic surfactant, not being an amine oxide,
c) 0.015-20% by weight of a cationic hydrotrope having the formula (I) 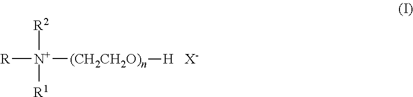
where R=C₆-C₂₂ hydrocarbyl, R¹ and R² are independently C₁-C₄ alkyl, n is at least 12, and at most 25; and X⁻ is an anion,
d) 0.03-40% by weight of alkali hydroxides, alkali builders and/or alkaline complexing agents
e) optionally other conventional additives selected from the group consisting of hydrotropes, surfactants, thickening agents, solvents, colorants, soil antiredeposition agents, preservatives, corrosion inhibitors and foam regulators, and
f) balance water;
where the weight ratio of the sum of amine oxide and nonionic surfactant to hydrotrope is between 1:3 and 5:3; and
with the proviso that if any anionic and/or amphoteric surfactant is present in the composition, then the molar amount of cationic hydrotrope of formula (I) is greater than the molar amount of any anionic groups that are part of an anionic and/or amphoteric surfactant.

12. The composition according to claim 11 comprising an anionic and/or amphoteric surfactant, wherein the molar ratio of anionic groups in the anionic and/or the amphoteric surfactant to cationic hydrotrope is less than 1:3.

13. The composition according to claim 11 where the composition is free of anionic and amphoteric surfactants.

14. The composition according to claim 11 comprising alkali hydroxides, alkaline builders and/or alkaline complexing agents.

15. The composition according to claim 11 where the amine oxide has the formula 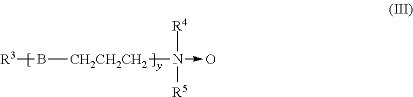
where R³ is a hydrocarbyl or acyl group containing 8-22 carbon atoms, B is O or NH and y is 0 or 1, provided that when R³ is an acyl group, y must be 1; R⁴ and R⁵ are, independently, a C₁-C₄ alkyl group or the group (AO)_{z}H, where AO is an alkyleneoxy group having 2-4 carbon atoms and z is a number from 1 to 5.

16. The composition according to claim 11 where the non-ionic surfactant has the formula
R⁶O—(PO)ₐ(EO)_{b}(PO)_{c}H (IV)
where R⁶ is a C₈ to C₁₈ hydrocarbyl group, PO is a propyleneoxy unit, EO is an ethyleneoxy unit, a=0-5, b=1-20, and c=0-5.

17. The composition according to claim 11 where the ratio of amine oxide to nonionic surfactant is between 1:2 and 8:3.
